(19) United States
(12) Patent Application Publication
(10) Pub. No.: US 2009/0050613 A1
(43) Pub. Date: Feb. 26, 2009

(54) Methods, Apparatus And Products For Welding Rotating Work Pieces

(76) Inventor: Harvey Prasek, Houston, TX (US)

Correspondence Address: GILBRETH & ASSOCIATES, P.C., PO BOX 2428, BELLAIRE, TX, 77402-2428, US

(21) Appl. No.: 11/843,699

(22) Filed: Aug. 23, 2007

(51) Int. Cl. B23K 9/32; B23K 9/10

(52) U.S. Cl. 219/130.1; 219/136

(57) ABSTRACT

An arc welding tool which includes a circular frame defining a passage for receiving a work piece, a carriage moveably positioned on the frame, and an electrical connector supported by the carriage, with an electrical path defined between the frame, carriage and electrical connector.

### BACKGROUND OF THE INVENTION

1. Field of the Invention

The present disclosure relates generally to welding. In another aspect, the present invention relates to methods, apparatus and products for welding. In even another aspect, the present invention relates to methods, apparatus and products for welding rotating work pieces.

2. Background of the Invention

Arc welding consists of fusing or joining at least two pieces of metal by establishing a metallurgical bond between them. The process of arc welding comprises the use of an electric welding power supply to create an electric arc between an electrode and a workpiece wherein the arc is used to melt a filler material at the welding point or region. During the welding process, the welding region may be protected by an inert or semi-inert gas referred to as a shielding gas. To produce the electric arc, the welding power supply is connected to the electrode and a ground lead is connected to a workpiece to create an electric circuit. Electrodes utilized in arc welding may be either consumable or non-consumable. Generally in arc welding processes comprising consumable electrodes, the electrode material is the filler material deposited at the weld. Examples of arc welding processes comprising use of consumable electrodes include shielded metal arc welding (SMAW), gas metal arc welding (GMAW), and submerged arc welding (SAW). For arc welding processes comprising non-consumable electrodes, addition of a filler material is required for the welding process. Examples of arc welding processes comprising non-consumable electrodes include gas tungsten arc welding (GTAW), also referred to as tungsten inert gas (TIG) welding, and a plasma arc welding.

Use of arc welding for production and fitting of pipe is known. Depending upon the application, the pipe sections or workpieces may be in a horizontal position, an inclined position, or a vertical position. Regardless of the pipe position, the weld region generally consists of the entire circumference of the pipe. In order to access the entire weld region it may be necessary to rotate either the pipe or the welding machinery during the welding process. With respect to rotation of the pipe, the pipe sections may be rotated by placing the pipe onto automated rollers/rotators, which rotate the pipe at a controlled rate during the welding process. Alternatively, pipe welding processes may comprise use of a motorized welder, which is guided on a track that has been fitted around the circumference of the pipe, thereby allowing the welding machinery to move around the circumference of the stationary pipe.

These approaches are not without drawbacks. For example, automated rollers are generally costly and require maintenance. Special lifting machinery may be required to position the pipe onto the rollers. In addition, the majority of roller apparatus are heavy and thus not readily portable from one job site/weld site to another. With respect to motorized welders, these are generally costly and require maintenance. Accurately fitting and positioning the guide tracks onto the circumference of the pipe at the weld region can also be a difficult and time consuming process.

Additionally, with the rotation of the pipe, the electrical power cord connect to the pipe with generally become wrapped around the pipe as the pipe rotates.

Despite advancements in the art, access to the weld region by welding machinery remains a challenge in pipe fitting applications. Apparatus and methods for arc welding pipe that do not suffer from the limitations of the prior art have not been described.

Thus, there is a need in the art for arc welding apparatus that provide proper positioning of workpieces.

There is another need in the art for pipe welding positioning apparatus that are portable and easy to operate.

There is even another need in the art for methods for arc welding pipe sections.

These and other needs in the art will become apparent to those of skill in the art upon review of this specification, including its drawings and claims

The present disclosure may provide methods, apparatus and/or products for the welding of rotating work pieces.

### SUMMARY OF THE INVENTION

The following presents a general summary of some of the many possible embodiments of this disclosure in order to provide a basic understanding of this disclosure. This summary is not an extensive overview of all embodiments of this disclosure. This summary is not intended to identify key or critical elements of the disclosure or to delineate or otherwise limit the scope of the claims. The following summary merely presents some concepts of the disclosure in a general form as a prelude to the more detailed description that follows.

According to one embodiment of the present invention, there is provided an arc welding tool. The tool may include a circular frame defining a passage for receiving a work piece. The tool may also include a carriage moveably positioned on the frame. The tool may also include an electrical connector supported by the carriage, with an electrical path defined between the frame, carriage and electrical connector.

According to another embodiment of the present invention, there is provided a system for arc welding a work piece. The system may include an electrical power source. The system may also include a welding rod in electrical communication with the power source for contacting with the work piece. The system may also include a circular frame defining a passage for receiving the work piece. The system may also include a carriage moveably positioned on the frame. The system may also include an electrical connector supported by the carriage, with an electrical path defined between the frame, carriage and electrical connector. When a work piece is received within the circular frame and the welding rod is in contact with the work piece, an electrical path is defined through the electrical power source, the welding rod, the work piece, the frame, the carriage, the electrical connector, to ground.

According to even another embodiment of the present invention, there is provided a method of arc welding. The method may include rotating a work piece to be welded, wherein the work piece supports a circular frame, with a carriage movably connected to the frame, with the carriage connected to ground, and wherein the track and the work piece rotate past the carriage during rotation. The method may also include contacting the work piece with a welding rod to which electrical power has been provided.

### BRIEF DESCRIPTION OF THE DRAWINGS

The following drawings illustrate some of the many possible embodiments of this disclosure in order to provide a basic understanding of this disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

FIG. 1 is a view of elongated tubular work piece 25 (a pipe in the embodiment as shown) on which is positioned electrode connector 100.

FIG. 2 is a detailed view of electrode connector 100, that includes track 102 on which is suspended connector carriage 103.

FIG. 3 is a side view of track 102 in the closed position.

FIG. 4 is a side view of track 102 in the open position.

FIG. 5 is a detail view of connector carriage 103.

FIG. 6 shows track 102 being inserted beneath rollers 110 of connector carriage 103 during assembly.

FIG. 7 is a downward view of connector carriage 102 suspended beneath track 102.

FIG. 8 is a schematic showing electrode connector 100 positioned on work piece 25, which is connected through conductive path 105 to ground 307, with electrical power provided from welding machine 301 through conductive path 303 to welding rod 302.

### DETAILED DESCRIPTION OF THE INVENTION

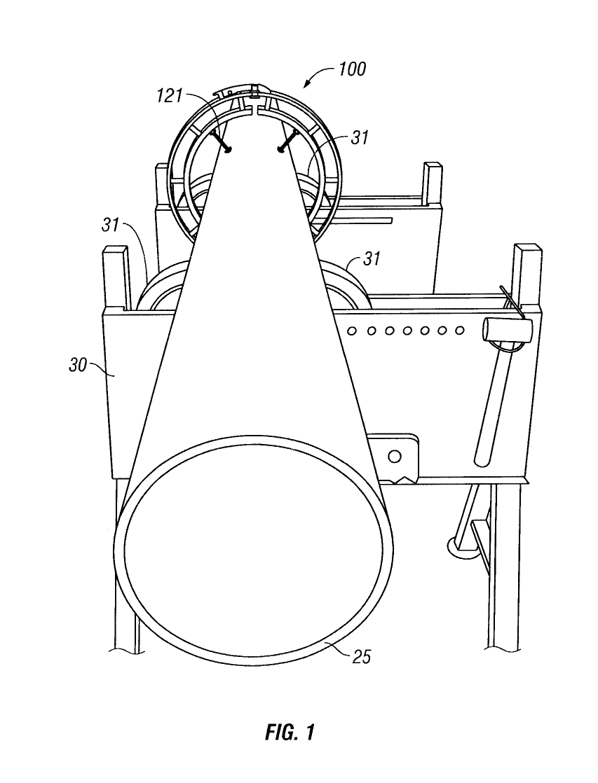

Referring first to FIG. 1, there is shown a view of elongated tubular work piece 25 (a pipe in the embodiment as shown) on which is positioned electrode connector 100. Rotating table 30 includes a plurality of powered wheels 31, which both support work piece 25 and rotate work piece 25 during welding. The rate of rotation of wheels 31 may be controlled to accommodate any welding scheme.

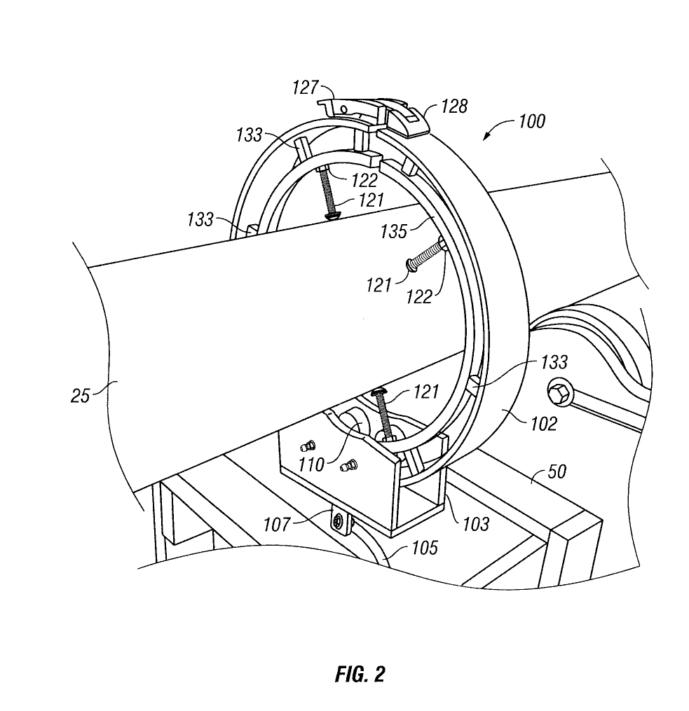

Referring additionally to FIG. 2, there is shown more detail of electrode connector 100. Specifically, electrode connector 100 includes a frame or track 102 on which is suspended connector carriage 103. Connector carriage 103 includes a plurality of wheels 110 which allow connector carriage 103 to be suspended from track 102. Cable 105 provides a ground for the current from an arc welding machine or other electrical power source. Cable 105 may be integral to connector carriage 103, or may be connected to connector carriage 103 at connector 107. The other end of cable 105 may be connected to a ground. The frame or track 102 defines a passage for receipt of work piece 25 During rotation of work piece 25, track 102 will move along with work piece 25, while wheels 110 will allow connector 103 to remain suspended underneath work piece 25. As another was of looking at it, during rotation of work piece 25, work piece 25 and track 102 will move past carriage 103. Depending upon the speed of rotation, frictional forces, and other factors, connector carriage 103 may move in the direction of rotation, although it is unlikely that connector carriage 103 would make more than just a partial rotation, and would most likely swing back underneath work piece 25 in a pendulum motion fashion. A carriage movement restrictor, such as frame 50 may optionally be provided in the travel path of carriage 103 to restrict such movement of connector carriage 103. This frame 50 is easily moveable to be as close to carriage 103 as necessary.

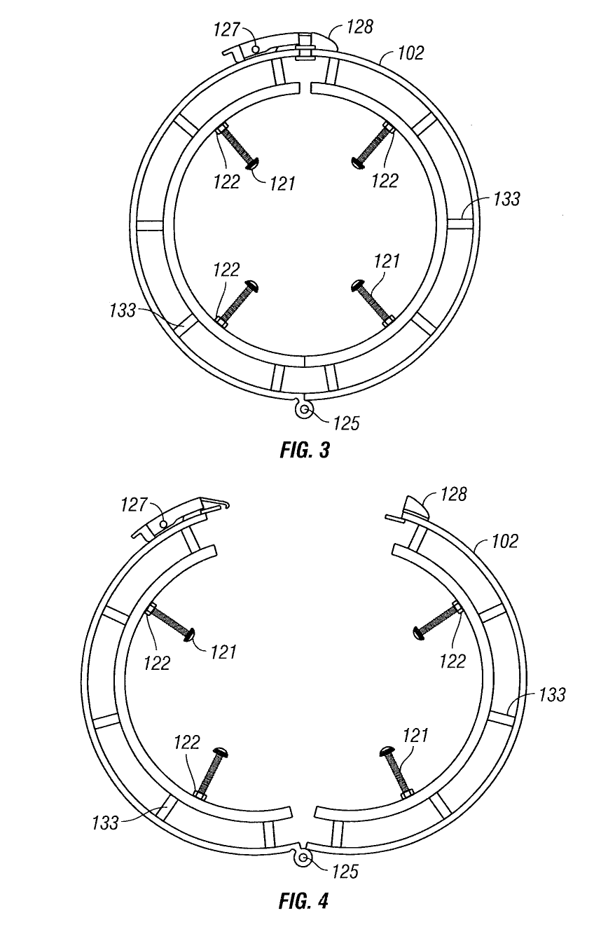

Referring additionally to FIGS. 3 and 4, there are shown side views of track 102 in the closed and opened positions, respectively. Track 102 may further include any number of reinforcing members 135, which is shown as being connected to track 102 by a plurality of stabilizer bars 133. Certainly, track 102 may be designed for a specific diameter of work piece. Alternatively, diameter adjustment members 121, may be provided to allow track 102 to be placed around work pieces of a range of diameters. These diameter adjustment members 121 are threaded and reside in threaded ports 122. Rotation of diameter adjustment members 121 will move those members inward or outward to adjust the diameter of work piece 25 which may be received.

Track 102 may be one continuous piece that is slipped over the end of work piece 25. Alternatively, track 102 may comprise two or more pieces which may be assembled around work piece 25. In the embodiment as shown, track 102 comprises two pieces 102A and 102B that are joined by hinge 125. Connector members 127 and 128, which in the embodiment shown are two pieces of an interlocking latch, lock track 102 in place around work piece 25. Certainly, any suitable connector system may be utilized.

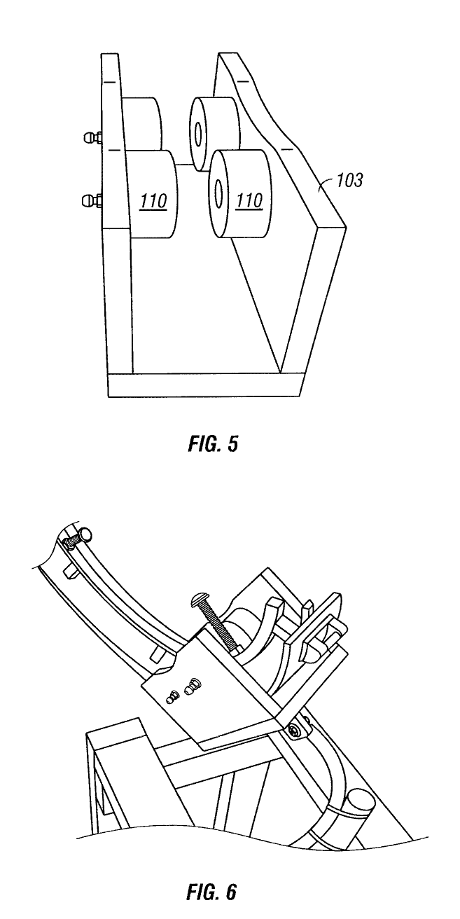

Referring additionally to FIG. 5 there is shown connector carriage 103. A plurality of rollers 110 allow connector 103 to move along track 102 and remain suspended underneath work piece 25.

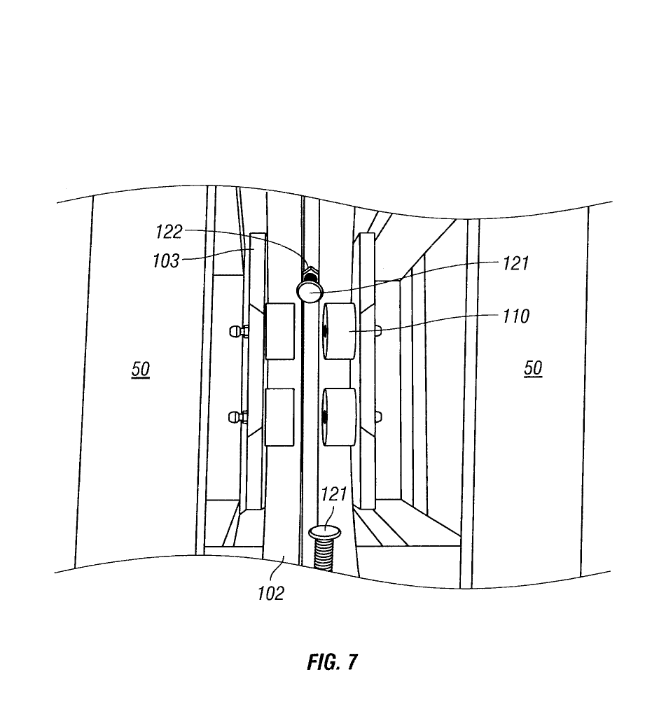

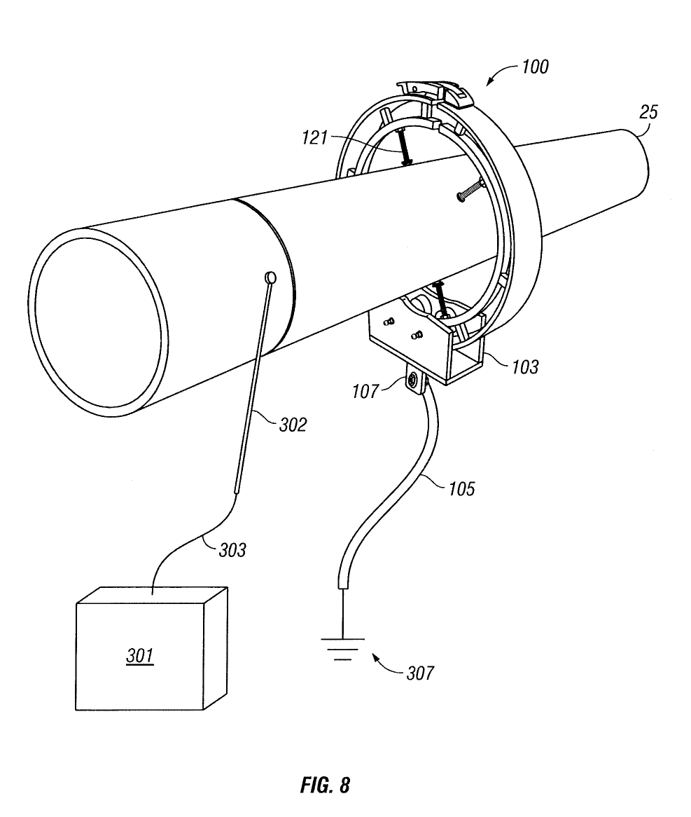

Referring additionally to FIGS. 6 and 7, there is shown connector carriage 103 and track 102. As shown in FIG. 6, during assembly track 102 is inserted beneath rollers 110 of connector carriage 103. Subsequently, track 102 is positioned around work piece 25 and secured in place with connectors 127 and 128. FIG. 7 is a downward view of connector carriage 102 suspended beneath track 102.

Electrode connector 100 is sufficiently conductive to allow for an electrical travel path from the power source to work piece 25. Generally the electrical travel path will be through connector carriage 103, through wheels 110, through track 102, through diameter adjustment members 121, to work piece 25. Generally, there are a sufficient number of diameter adjustment members 121 to allow for efficient current flow to work piece 25.

FIG. 8 is a schematic showing electrode connector 100 positioned on work piece 25, which is connected through conductive path 105 to ground 307, with electrical power provided from welding machine 301 through conductive path 303 to welding rod 302.

In operation, diameter adjustment members 121 are positioned suitable for the diameter of work piece 25. Track 102 is then inserted into position beneath rollers 110 of connector carriage 103. Track 102 is then assembled around work piece 25. During rotation of work piece 25, track 102 will rotate in conjunction with work piece 25. Connector carriage 103 will remain relatively beneath work piece 25 as rollers 110 allow track 102 to move relative to carriage 103. Frame 50 may optionally restrict movement of carriage 103. Power is provided from welding machine 301 to welding rod 302, with work piece 25 being grounded through electrode connector 100.

Various embodiments of methods of the present invention may include any one or more of the following: attaching the connector of the present invention to a work piece; connecting the connector to ground; rotating the work piece; and contacting the rotating work piece with a welding rod connected to an electrical power source.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Any insubstantial variations are to be considered within the scope of the claims below.

What is claimed is:

1. An arc welding tool comprising:
a circular frame defining a passage for receiving a work piece;
a carriage moveably positioned on the frame;
an electrical connector supported by the carriage, with an electrical path defined between the frame, carriage and electrical connector.

2. The tool of claim 1, further comprising:
work piece connectors extending radially from the frame and into the passage.

3. The tool of claim 2, wherein the work piece connectors are adjustable to extend various distances from the frame.

4. The tool of claim 1, wherein the carriage comprises rollers in contact with the frame.

5. The tool of claim 1, wherein the electrical connector is connected to ground.

6. The tool of claim 1, wherein the frame comprises two pieces members which are pivotally connected.

7. The tool of claim 1, further comprising a carriage movement restrictor positioned to restrict movement of the carriage.

8. A system for arc welding a work piece comprising:
an electrical power source;
a welding rod in electrical communication with the power source for contacting with the work piece;
a circular frame defining a passage for receiving the work piece;
a carriage moveably positioned on the frame;
an electrical connector supported by the carriage, with an electrical path defined between the frame, carriage and electrical connector;
wherein when a work piece is received within the circular frame and the welding rod is in contact with the work piece, an electrical path is defined through the electrical power source, the welding rod, the work piece, the frame, the carriage, the electrical connector, to ground.

9. The system of claim 8, further comprising:
work piece connectors extending radially from the frame and into the passage.

10. The system of claim 9, wherein the work piece connectors are adjustable to extend various distances from the frame.

11. The system of claim 8, wherein the carriage comprises rollers in contact with the frame.

12. The system of claim 8, wherein the electrical connector is connected to ground.

13. The system of claim 8, wherein the frame comprises two members which are pivotally connected.

14. The system of claim 8, further comprising a carriage movement restrictor positioned to restrict movement of the carriage.

15. A method of arc welding comprising:
Rotating a work piece to be welded, wherein the work piece supports a circular frame, with a carriage movably connected to the frame, with the carriage connected to ground, and wherein the track and the work piece rotate past the carriage during rotation; and
Contacting the work piece with a welding rod to which electrical power has been provided.
